(19) United States
(12) Patent Application Publication
(10) Pub. No.: US 2014/0337788 A1
(43) Pub. Date: Nov. 13, 2014

(54) METHOD AND DEVICE FOR TEXT MESSAGE INPUT

(71) Applicant: TENCENT TECHNOLOGY (SHENZHEN) COMPANY LIMITED, Shenzhen City (CN)

(72) Inventors: BO HU, Shenzhen City (CN); ZHI-PEI WANG, Shenzhen City (CN); RUI-YI ZHOU, Shenzhen City (CN); XI WANG, Shenzhen City (CN); KAI ZHANG, Shenzhen City (CN); XIN QING, Shenzhen City (CN); HUI-JIAO YANG, Shenzhen City (CN); YING HUANG, Shenzhen City (CN); YU-LEI LIU, Shenzhen City (CN); WEI LI, Shenzhen City (CN); CHENG FENG, Shenzhen City (CN)

(73) Assignee: TENCENT TECHNOLOGY (SHENZHEN) COMPANY LIMITED, Shenzhen City (CN)

(21) Appl. No.: 14/257,972

(22) Filed: Apr. 21, 2014

Related U.S. Application Data
(63) Continuation of application No. PCT/CN2014/070030, filed on Jan. 2, 2014.

(30) Foreign Application Priority Data
May 8, 2013 (CN) 201310165974.0

(51) Int. Cl. G06F 3/0481

(52) U.S. Cl. CPC G06F 3/0481
USPC 715/780

(57) ABSTRACT

A method for text message input is provided. The method includes the following steps. Firstly, a text-editing box is generated while a text input in a text input region is detected, wherein an input area of the text-editing box is larger than that of the text input region. Then, a text message inputted in the text-editing box is received. Next, an editing-done instruction from the text-editing box is received after the text message is inputted. Finally, the text message is transmitted from the text-editing box to the text input region. A device for text message input is also provided.

### CROSS-REFERENCE TO RELATED APPLICATION

This application is a continuation application of International (PCT) Patent Application No. PCT/CN2014/070030 filed on Jan. 2, 2014, now pending and designating the United States, which also claims benefit of China Patent Application No. 201310165974.0, filed on May 8, 2013. The entirety of the above-mentioned patent applications is hereby incorporated by reference herein and made a part of this specification.

### FIELD OF THE INVENTION

The present invention relates to the field of communication, and more particularly to a method and a device for text message input.

### BACKGROUND OF THE INVENTION

With the popularity of mobile terminals, the various functions of the mobile terminals are demanded increasingly. Take touch screen phones for example, text messages are usually inputted in text input regions, such as, a text input box for short message input, for search on a web page or internet, or for account and password inputs to login an account.

In general, an input area of the text input region in the mobile terminal is small due to the size limitation of the display screen. When lots of texts are inputted within the small input area of the text input region, a portion of the inputted texts may not be shown. It is need to move the cursor to read all the inputted texts line by line. Besides, it is usually need to delete and input again for correcting typo. Thus, it is very troublesome and inefficient for users.

With reference to FIG. 1, a conventional text input box on a browser in a mobile terminal is schematically illustrated. On a screen 100 of a mobile terminal, only a few words can concurrently be displayed on a text input box 10 by virtue of its small input area so as to impair the efficiency of amendment or edition to inputted texts. Therefore, it is desirable for solving the problem of text message inputs.

### SUMMARY OF THE INVENTION

In accordance with an aspect, the present invention provides a method for text message input. The method includes the following steps. Firstly, a text-editing box is generated while a text input in a text input region is detected, wherein an input area of the text-editing box is larger than that of the text input region. Then, a text message inputted in the text-editing box is received. Next, an editing-done instruction from the text-editing box is received after the text message is inputted. Finally, the text message is transmitted from the text-editing box to the text input region.

In an embodiment, the step of generating a text-editing box while a text input in a text input region is detected includes the following sub-steps. Firstly, the method determines whether an instruction for generating the text-editing box is received while the text input in the text input region is detected. Next, the text-editing box is generated when the instruction for generating the text-editing box is received.

In an embodiment, the step of generating a text-editing box while a text input in a text input region is detected further includes the following sub-steps. The text-editing box is pre-set. Moreover, the pre-set text-editing box and an adjustment button are connected, wherein the adjustment button is used to adjust the text-editing box.

In an embodiment, the step of generating a text-editing box while a text input in a text input region is detected further includes the following sub-steps. Firstly, the method determines whether the text input region receives a text input instruction. Next, the adjustment button is generated when the text input region receives the text input instruction, wherein the adjustment button is used to receive the instruction for generating the text-editing box.

In an embodiment, a prompt message is generated in the text-editing box to prompt an input position of the text message when the text-editing box is generated.

In an embodiment, the text input region is covered when the text-editing box is generated.

In accordance with another aspect, the present invention provides a device for text message input including a text-editing box generation module, a first text message processing module, an instruction processing module, and a second text message processing module. The text-editing box generation module is configured to generate a text-editing box while a text input in a text input region is detected. Besides, an input area of the text-editing box is larger than that of the text input region. The first text message processing module is configured to receive a text message inputted in the text-editing box. The instruction processing module is configured to receive an editing-done instruction in the text-editing box after the text message is inputted. The second text message processing module is configured to transmit the text message from the text-editing box to the text input region.

In an embodiment, the text-editing box generation module includes a determination unit and a generation unit. The determination unit is configured to determine whether an instruction for generating the text-editing box is received while the text input in the text input region is detected. In addition, the generation unit is configured to generate the text-editing box when the instruction for generating the text-editing box is received.

In an embodiment, the text-editing box generation module further includes a pre-setting unit configured to pre-set the text-editing box and then connecting the pre-set text-editing box and an adjustment button. Moreover, the adjustment button is configured to adjust the text-editing box.

In an embodiment, the determination unit is configured to determine whether the text input region receives a text input instruction. Then, the generation unit generates the adjustment button when the determination unit determines that the text input region receives the text input instruction. Additionally, the adjustment button is configured to receive the instruction for generating the text-editing box.

In an embodiment, the text-editing box generation module is further configured to generate a prompt message in the text-editing box to prompt an input position of the text message when the text-editing box is generated.

In an embodiment, a covering module is configured to cover the text input region when the text-editing box is generated by the text-editing box generation module.

### BRIEF DESCRIPTION OF THE DRAWINGS

The present invention will become more readily apparent to those ordinarily skilled in the art after reviewing the following detailed description and accompanying drawings, in which:

FIG. 1 is a schematic diagram illustrating a conventional text input box on a browser in a mobile terminal;

FIG. 2 is a schematic diagram illustrating a method for text message input according to one embodiment of the present invention;

FIGS. 3A-3C are schematic diagrams illustrating action of a text-editing box according to one embodiment of the present invention;

FIGS. 4A-4B are schematic diagrams illustrating a method for text message input according to another embodiment of the present invention; and

FIG. 5 is a schematic diagram illustrating a device for text message input according to one embodiment of the present invention.

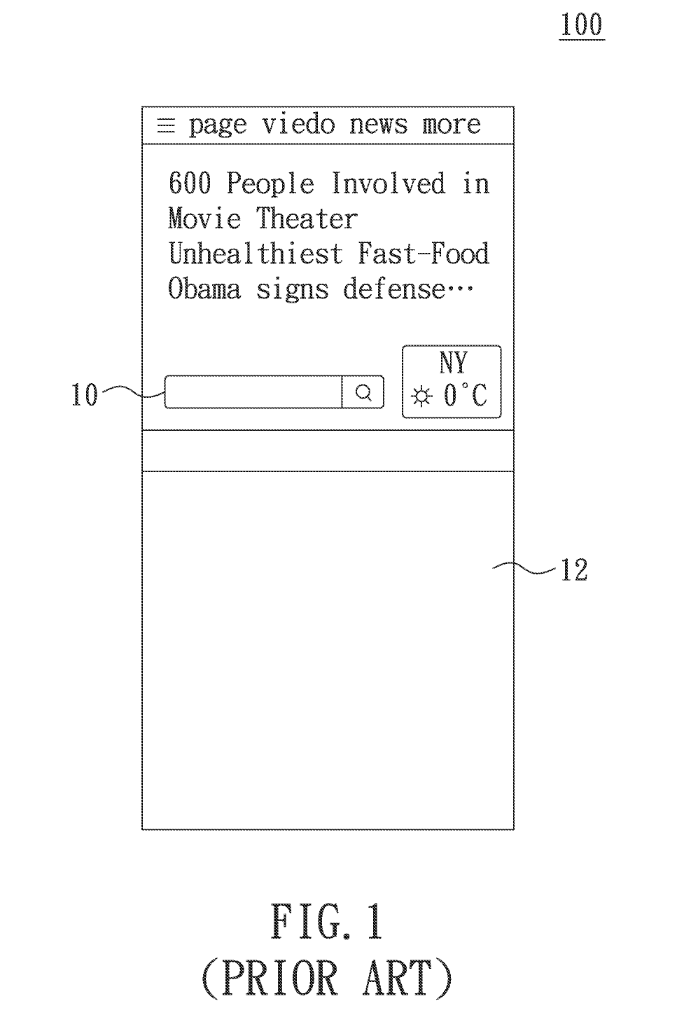

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

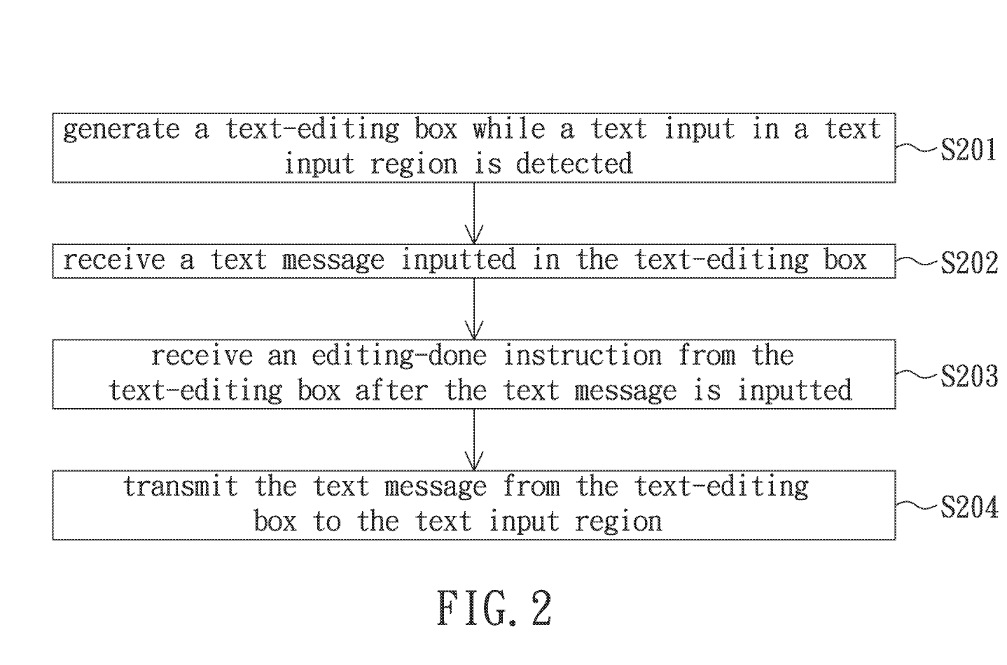

Regarding to FIG. 2, a method for text message input according to one embodiment of the present invention schematically illustrated. In this embodiment, the method may include several steps, such as, S201 to S204.

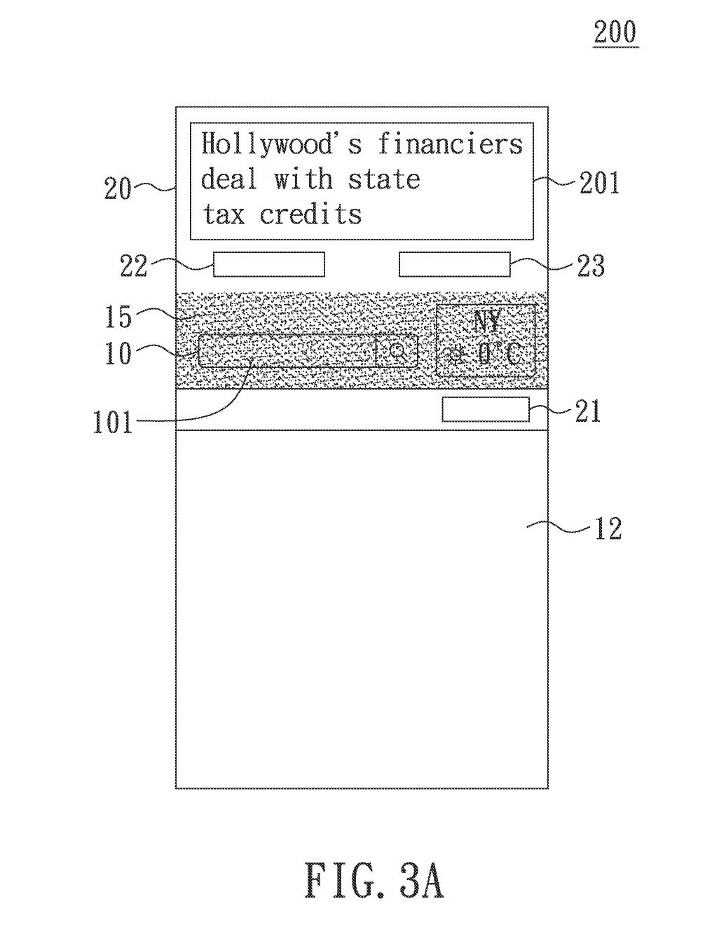

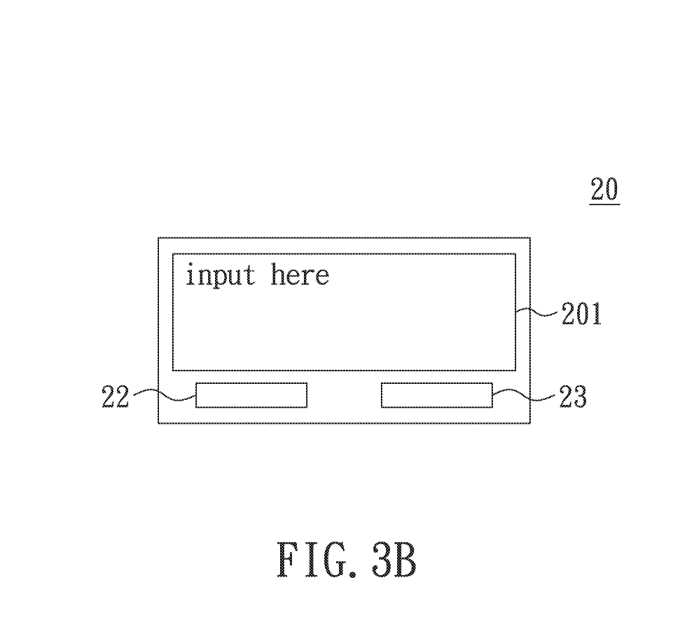

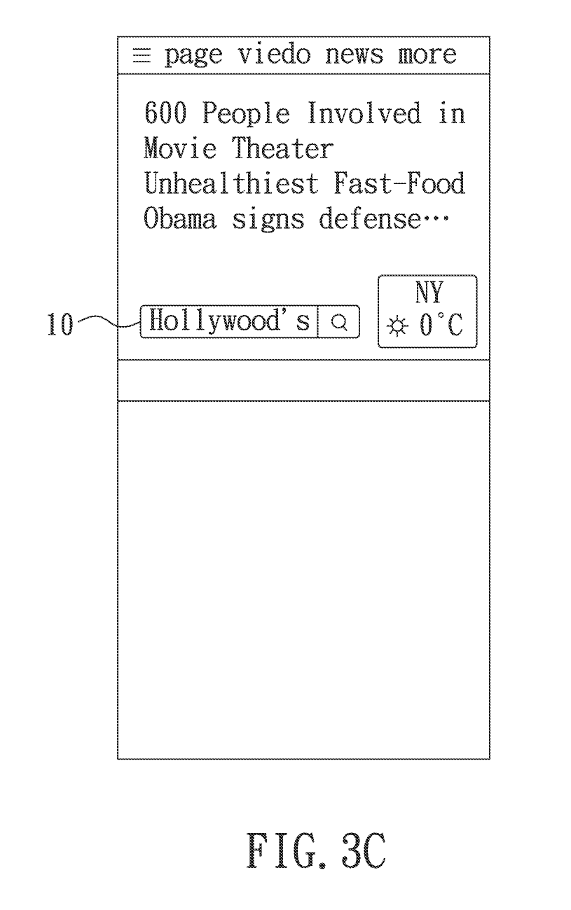

In Step S201, generating a text-editing box while a text input in a text input region is detected. Additionally, an input area of the text-editing box is larger than that of the text input region. Please also see FIGS. 3A-3C, action of a text-editing box according to one embodiment of the present invention is illustrated. In the embodiment, a text input region 10 may be a text input box for short message input, for search on a web page, or for account and password inputs to login an account. The text input region 10 may also be disposed at any place on a screen 200 of the mobile terminal. When a user performs a text input in the text input region 10, a text-editing box 20 is generated. It is to be noted that an input area 201 of the text-editing box 20 is larger than an input area 101 of the text input region 10. Moreover, the text input region 10 may be covered by a dark or dim region 15 when the text-editing box 20 is generated so that the text input region 10 loses input function temporarily.

In Step 202, receiving a text message inputted in the text-editing box. In the embodiment of the instant application, a text message, e.g. characters or symbols, is entered into the text-editing box 20 via a keyboard 12. Thanks to the larger input area 201 of the text-editing box 20, the whole text message may be displayed therein so as to be amended, edited or processed more conveniently and efficiently.

In Step 203, receiving an editing-done instruction after the text message is inputted in the text-editing box. Specifically, after finishing inputting the text message in the text-editing box 20, the user may click a “confirm” button 22 at the text-editing box 20 so that an editing-done instruction is received.

In Step 204, transmitting the text message from the text-editing box to the text input region. In the embodiment of the present invention, after the “confirm” button 22 is clicked, the mobile terminal receives the editing-done instruction. Then, the text message is transmitted from the text-editing box 20 to the text input region 10. The text-editing box 20 disappears and the text message is entered in the text input region 10.

Only a portion of the text message may be concurrently displayed on the uncovered text input region 10 because of the smaller input area 101 thereof. However, the text message has been edited completely in the text-editing box 20. Thus, it is not necessary to edit the text message in the smaller area 101 of the text input region 10. Consequently, the method embodiment of the present invention may solve the problems described in the background section of the present application.

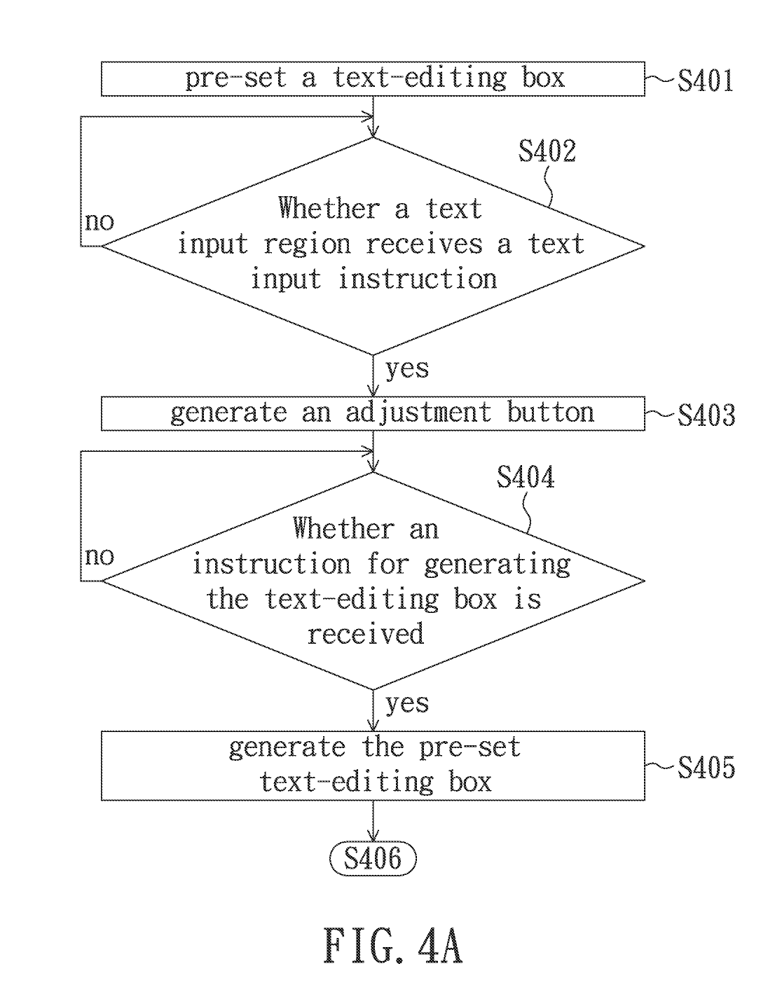

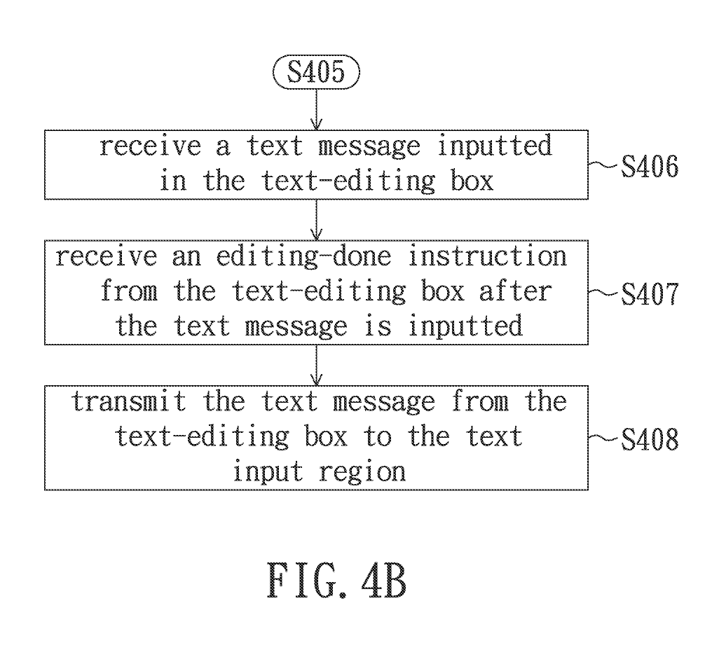

With reference to FIGS. 4A-4B, a method for text message input according to another embodiment of the present invention is schematically illustrated. In the embodiment, the method for text message input may include steps of S401 to S408.

In Step S401, pre-setting a text-editing box and connecting the pre-set text-editing box and an adjustment button. In the embodiment of the present invention, the text-editing box 20 having a certain interface type is pre-set in mobile terminal software by coding for example. The text-editing box 20, for instance, has the input area 201 greater than the input area 101 of the text input region 10, as shown in FIG. 3A. The pre-set adjustment button is used to adjust the text-editing box 20.

In Step S402, determining whether the text input region receives a text input instruction. If yes, Step S403 is performed; otherwise, Step S402 is performed again. In the embodiment of the present invention, the user may send the text input instruction to the text input region 10 by clicking the input area 101.

In Step 403, generating the adjustment button. As shown in FIG. 3A, the pre-set adjustment button 21 is generated or displayed on the screen 200 of the mobile terminal when the text input region 10 receives the text input instruction. The adjustment button 21 may show “enlarge” thereon.

In Step S404, determining whether the instruction for generating the text-editing box is received. If yes, Step S405 is performed; otherwise, Step S404 is performed again. In the embodiment, the adjustment button 21 may be used to receive an instruction for generating the text-editing box. The user may send the instruction for generating the text-editing box by pressing the adjustment button 21.

In Step S405, generating the text-editing box. Specifically, after the user press the adjustment button 21, the instruction for generating the text-editing box is received and then the pre-set text-editing box 20 is shown on the screen 200. In addition, the text-editing box 20 may have a “confirm” button 22 and a “cancel” button 23.

With reference to FIG. 3B, a prompt message e.g. “input here” as a sign, may be generated in the text-editing box 20 to prompt an input position of the text message when the text-editing box 20 is generated. For instance, after the text-editing box 20 is clicked or touched, a blinking cursor is shown at the position where the sign“input here” is.

Furthermore, the text input region may be covered when Step S405 is performed. That is, when the pre-set text-editing box 20 is displayed on the screen 200, the text input region 10 may be blocked from text message input. As shown in FIG. 3A, the text input region 10 may be covered by a dark or dim region 15.

In Step S406, receiving a text message inputted in the text-editing box. The user may enter a text message, e.g. characters or symbols, into the text-editing box 20 by the keyboard 12 or a speech recognition acceptor. As a result of the larger input area 201 of the text-editing box 20, the whole text message may be shown therein. Therefore, the efficiency may be obviously increased for amendment, edition or other processes to the inputted text message.

In Step S407, receiving an editing-done instruction after the text message is inputted in the text-editing box. Specifically, after finishing inputting the text message in the text-editing box 20, the user may click a “confirm” button 22 at the text-editing box 20 so that an editing-done instruction is received.

In Step S408, transmitting the text message from the text-editing box to the text input region. In the embodiment of the present invention, after the “confirm” button 22 is clicked, the mobile terminal receives the editing-done instruction. Then, the text message is transmitted from the text-editing box 20 to the text input region 10. For example, the dark or dim region 15 is gone and then the text message is shown on the input region 101 of the uncovered text input region 10. Besides, the text-editing box 20 also disappears from the screen 200.

In addition, the user may stop transmitting the text message by pressing the “cancel” button 23 so that both the text-editing box 20 and the dark region 15 may disappear from the screen 200.

Only a portion of the text message may be concurrently displayed on the uncovered text input region 10 because of the smaller input area 101 thereof. However, the text message has been edited completely in the text-editing box 20. Thus, it is not necessary to edit the text message in the smaller area 101 of the text input region 10. Consequently, the method embodiment of the present invention can be capable of enhancing the efficiency and convenience for text message input in the mobile terminal.

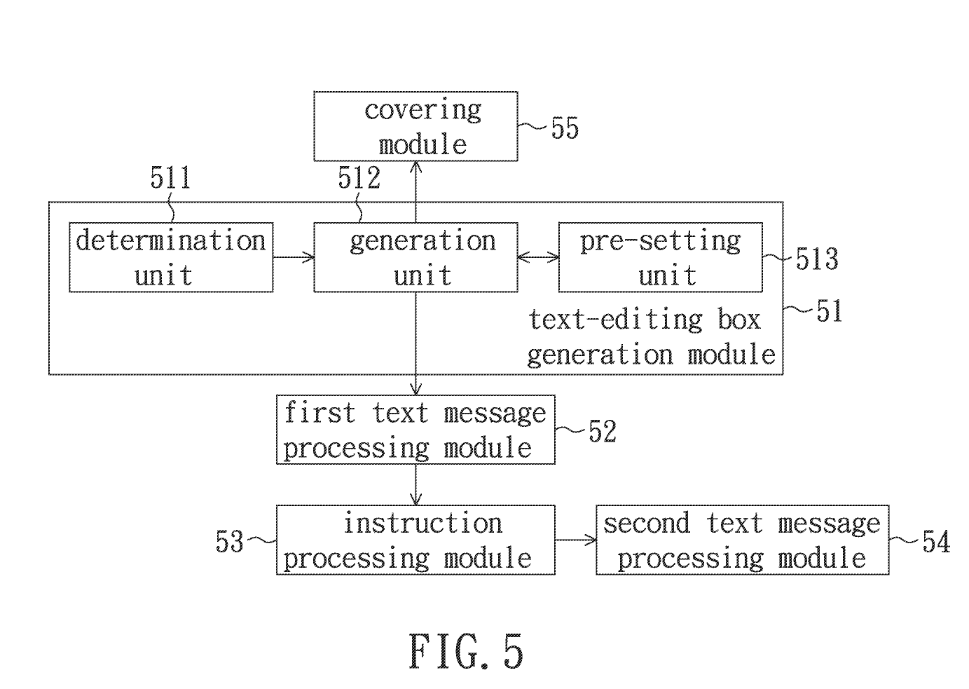

With reference to FIG. 5, a device for text message input according to one embodiment of the present invention is schematically illustrated. The device for text message input may include a text-editing box generation module 51, a first text message processing module 52, an instruction processing module 53, and a second text message processing module 54.

Please also see FIG. 3A. When a text input in a text input region 10 is detected, the text-editing box generation module 51 may generate a text-editing box 20 which has an input area 201 larger than an input area 101 of the text input region 10. In the embodiment, the text input region 10 may be a text input box for short message input, for search on a web page or internet, or for account and password inputs to login an account. The text input region 10 may also be disposed at any place on the screen 200 of the mobile terminal.

The first text message processing module 52 may receive a text message inputted in the text-editing box 20. In the embodiment of the instant application, when a text message is entered into the text-editing box 20, the first text message processing module 52 would receive the text message. The text message may be edited and amended completely in the larger input area 201 of the text-editing box 20 without scrolling up/down or shifting the text message.

The instruction processing module 53 may receive an editing-done instruction in the text-editing box after the text message is inputted. Specifically, after finishing inputting the text message in the text-editing box 20, the user may click the “confirm” button 22 at the text-editing box 20 so that the instruction processing module 53 receives the editing-done instruction.

When the editing-done instruction is received, the second text message processing module 54 may transmit the text message from the text-editing box 20 to the text input region 10. Thus, the text message is shown on the input area 101 of the text input region 10.

Only a portion of the text message may be concurrently displayed on the uncovered text input region 10 because of the smaller input area 101 thereof. However, the text message has been edited completely in the text-editing box 20. Thus, it is not necessary to edit the text message in the smaller area 101 of the text input region 10. Consequently, the method embodiment of the present invention may solve the problems described in the background section of the present application.

In one embodiment of the present invention, the text-editing box generation module 51 may include a determination unit 511, a generation unit 512 and a pre-setting unit 513, as shown in FIG. 5.

The pre-setting unit 513 may set a text-editing box previously and an adjustment button; and establish a connection between both. The pre-set text-editing box having a certain type, e.g. size or shape, may be pre-set in mobile terminal software by coding for example. The pre-set adjustment button 21 is used to adjust the text-editing box 20.

The determination unit 511 may be configured to determine whether the text input region 10 receives a text input instruction. If the input area 101 of the text input region 10 is touched, the determination unit 511 may determine that the text input instruction is received. When the determination unit 511 determines that the text input region 10 receives the text input instruction, the generation unit 512 may generate the pre-set adjustment button 21 which may show “enlarge” thereon for example.

Furthermore, the determination unit 511 is also configured to determine whether an instruction for generating the text-editing box is received. If yes, the generation unit 512 may generate the text-editing box 20 pre-set by the pre-setting unit 513. Specifically, when the adjustment button 21 is pressed, the instruction for generating the text-editing box is received. Then, the text-editing box 20 is generated and have the input area 201 greater than the input area 101 of the text input region 10, as shown in FIG. 3A. Besides, the text-editing box 20 may include a “confirm” button 22 and a “cancel” button 23.

In the embodiment of the present invention, the text-editing box generation module 51 is further configured to generate a prompt message in the text-editing box 20. The prompt message may be a sign “input here” to show a start position for the text message input, as suggested in FIG. 3B. When the input area 201 of the text-editing box 20 is clicked or touched, a blinking cursor is shown at the start position where the sign “input here” is.

Regarding to FIG. 5, the device for text message input further comprises a covering module 55 configured to cover the text input region 10 when the text-editing box 20 is generated. Thus, the user may not directly input the text message into the text input region 10.

Then, the first text message processing module 52 may receive a text message inputted in the text-editing box 20. The instruction processing module 53 may receive an editing-done instruction in the text-editing box 20 after the text message is inputted. When the editing-done instruction is received, the second text message processing module 54 may transmit the text message from the text-editing box 20 to the text input region 10.

Hence, the text message may be edited completely in the text-editing box 20 with larger input area 201. Consequently, the device embodiment of the present invention may be capable of enhancing the efficiency and convenience for text message input in the mobile terminal.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for text message input, comprising steps of:
generating a text-editing box while a text input in a text input region is detected, wherein an input area of the text-editing box is larger than that of the text input region;
receiving a text message inputted in the text-editing box;
receiving an editing-done instruction from the text-editing box after the text message is inputted; and
transmitting the text message from the text-editing box to the text input region.

2. The method for text message input according to claim 1, wherein the step of generating a text-editing box while a text input in a text input region is detected comprises:
determining whether an instruction for generating the text-editing box is received while the text input in the text input region is detected; and
generating the text-editing box when the instruction for generating the text-editing box is received.

3. The method for text message input according to claim 2, wherein the step of generating a text-editing box while a text input in a text input region is detected further comprises:
pre-setting the text-editing box; and
connecting the pre-set text-editing box and an adjustment button, wherein the adjustment button is used to adjust the text-editing box.

4. The method for text message input according to claim 3, wherein the step of generating a text-editing box while a text input in a text input region is detected further comprises:
determining whether the text input region receives a text input instruction; and
generating the adjustment button when the text input region receives the text input instruction, wherein the adjustment button is used to receive the instruction for generating the text-editing box.

5. The method for text message input according to claim 1, further comprising a step of generating a prompt message in the text-editing box to prompt an input position of the text message when the text-editing box is generated.

6. The method for text message input according to claim 1, further comprising a step of covering the text input region when the text-editing box is generated.

7. A device for text message input, comprising:
a text-editing box generation module, configured to generate a text-editing box while a text input in a text input region is detected, wherein an input area of the text-editing box is larger than that of the text input region;
a first text message processing module, configured to receive a text message inputted in the text-editing box;
an instruction processing module, configured to receive an editing-done instruction in the text-editing box after the text message is inputted; and
a second text message processing module, configured to transmit the text message from the text-editing box to the text input region.

8. The device for text message input according to claim 7, wherein the text-editing box generation module comprises: a determination unit and a generation unit;
wherein the determination unit is configured to determine whether an instruction for generating the text-editing box is received while the text input in the text input region is detected; and
wherein the generation unit is configured to generate the text-editing box when the instruction for generating the text-editing box is received.

9. The device for text message input according to claim 8, wherein the text-editing box generation module further comprises:
a pre-setting unit, configured to pre-set the text-editing box and then connecting the pre-set text-editing box and an adjustment button, wherein the adjustment button is configured to adjust the text-editing box.

10. The device for text message input according to claim 9, wherein the determination unit is configured to determine whether the text input region receives a text input instruction, wherein the generation unit generates the adjustment button when the determination unit determines that the text input region receives the text input instruction, wherein the adjustment button is configured to receive the instruction for generating the text-editing box.

11. The device for text message input according to claim 7, wherein the text-editing box generation module is further configured to generate a prompt message in the text-editing box to prompt an input position of the text message when the text-editing box is generated.

12. The device for text message input according to claim 7, further comprising a covering module, configured to cover the text input region when the text-editing box is generated by the text-editing box generation module.
